(19) United States
(12) Patent Application Publication
(10) Pub. No.: US 2009/0226864 A1
(43) Pub. Date: Sep. 10, 2009

(54) Language skill development according to infant age

(76) Inventors: Anat Thieberger Ben-Haim, Kiryat Tivon (IL); Gil Thieberger, Kiryat Tivon (IL); Tal Thieberger, Kiryat Tivon (IL); Shaul Thieberger, Kiryat Tivon (IL)

Correspondence Address: Active Knowledge Ltd., POB 294, Kiryat Tivon, 36010, omitted

(21) Appl. No.: 12/401,358

(22) Filed: Mar. 10, 2009

Related U.S. Application Data
(60) Provisional application No. 61/035,027, filed on Mar. 10, 2008.
(60) Provisional application No. 61/110,080, filed on Oct. 31, 2008.

(51) Int. Cl. G09B 5/00; G09B 5/04

(52) U.S. Cl. 434/169; 434/319

(57) ABSTRACT

Methods and devices operative to play auditory pieces to an infant for stimulating the development of phonetic categories. Optionally, the device determines the auditory pieces to be played to the infant according to the age of the infant. The auditory pieces including isolated phonemes in the infant's parent's voice.

### CROSS-REFERENCE TO RELATED APPLICATIONS

This application claims the benefit of U.S. Provisional Patent Application No. 61/035,027, filed Mar. 10, 2008, and U.S. Provisional Patent Application No. 61/110,080, filed Oct. 31, 2008, incorporated herein by reference.

### FIELD OF THE INVENTION

The disclosed embodiments relate to methods and devices for language skill development according to infant age.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the musical notations, musical pieces, songs, educational materials, data, methods, guidelines, and software as described herein and in the drawings that form a part of this document: Copyright© 2008, Anat Thieberger Ben-Haim. All Rights Reserved.

### BACKGROUND

The world's languages contain hundreds of phonemes, comprised of consonants, vowels, and diphthongs, while a specific language contains just a small subgroup of the world's phonemes. Until the age of about 3-6 months, infants are usually able to distinguish between almost all phonemes. At about that time, the infant brain begins to sort out the phoneme sounds into a much smaller subset based on exposure to the infant's native language. This small subset may be referred to as phonetic representations, or phonetic categories. Phonetic categories underlie all further learning of lexical items, and are essential for both the establishment of a vocabulary and the acquisition of word meanings. A single-lingual adult's brain is tuned to readily distinguish one phoneme from another in his/her native language but often fails to do so when exposed to foreign phonemes.

If a foreign phoneme is similar to, but differs slightly from, a native phoneme, a tuned brain may fail to readily distinguish or enunciate the foreign phoneme, and might instead substitute it with a native phoneme. For example, when a Japanese listener who understands only native Japanese hears the English word “river”, he/she may not be able to readily distinguish the non-Japanese [ri] sound from a native [li] sound and may hear something closer to “liver.” When asked to repeat the word, the Japanese listener, having no vocalization training to speak the [ri] phoneme, may also say “liver.”

US patent application number 20040067471, entitled “phoneme playback system for enhancing language learning skills”, incorporated herein by reference, and the “Babbler” educational language toy, by Neurosmith, play series of phonemes and words to infants and children. Unfortunately, they have not been effective in stimulating the development of phonetic categories.

### BRIEF SUMMARY

Some of the disclosed embodiments stimulate the development of phonetic categories at the stage of development in which the infant's brain sorts out the different phoneme sounds into a subset of about 30 to 60 phonetic categories. If exposure to the auditory pieces, which comprise isolated phonemes, is long enough, the infant brain will be able to sort out the different phoneme sounds into a larger subset than if the infant had been exposed only to its native language. For example, the infant brain may be able to sort out the different phoneme sounds into about 60 to 70 phonetic categories based on exposure to its native language and exposure to embodiments of the disclosed auditory pieces from the age of about 4 to 10 months. A brain having a subset of about 60 to 70 phonetic categories, rather than 50 phonetic categories, is better tuned to recognize native and foreign language phonemes. Such a brain may also be able to pronounce and distinguish between more phonemes.

According to some theories, in order to be able to understand and pronounce a certain word, the human brain should be able to identify the phonemes that constitute the word. Some of the embodiments train the brain to identify required phonemes that are in use in predefined languages. The training includes listening to auditory pieces that are comprised of phonemes, with or without a melody. Optionally, the melody is easy to remember and/or easy to grasp.

Moreover, some of the embodiments improve the infant's ability to grasp his/her native language and foreign languages, to understand the sounds he/she hears, and/or to train her subconscious to identify the basic elements that comprise a language.

In some cases, infants are more attentive to their mother's voice than to other voices. In some embodiments, in order to increase the effectiveness of the auditory pieces, one or more of the infant's parents record the phonemes to be played in their own voice. Some of the embodiments expand the parent's infant-directed speech to a large set of phonemes that the parents usually do not pronounce, and repeat each phoneme many times in order to sufficiently stimulate the infant brain to expand the phonetic categories. This may also help the infant to identify and fixate/focus on required phonemes.

In some of the embodiments, various vowels, consonants, and/or diphthongs/digraphs/trigraphs, referred to herein as phonemes or isolated phonemes, are played to an infant. The set of phonemes played to an infant may be selected to approximately cover the required language(s). Optionally, each phoneme is pronounced using an easy to grasp melody. Optionally, the phonemes may be pronounced using one or more voices. The series of phonemes played to the infant may not have a linguistic or lexicographic meaning. Optionally, the auditory pieces may be played to the infant during the day and night, or only during the day or the night, or as required.

One embodiment discusses a device operative to play auditory pieces to an infant for stimulating the development of phonetic categories; the device determines the auditory pieces to be played to the infant according to the age of the infant; and the auditory pieces comprising isolated phonemes in the infant's parent's voice.

One embodiment discusses a device for playing auditory pieces, comprising: a memory element operative to store prerecorded auditory pieces in the infant's parent's voice; a computing element programmed to select at least one auditory piece to be played, according to the infant's age.

One embodiment discusses a method for preparing an auditory piece for prelingual language development, comprising: registering an infant's age; accessing at least one phoneme recorded in the infant's parent's voice; and building an auditory piece from the recorded phoneme, appropriate to the infant's age.

Implementations of the disclosed embodiments involve performing or completing selected tasks or steps manually, semi-automatically, fully automatically, and/or a combination thereof. Moreover, depending upon actual instrumentation and/or equipment used for implementing the disclosed embodiments, several embodiments could be achieved by hardware, by software, by firmware, or a combination thereof. In particular, with hardware, embodiments of the invention could exist by variations in the physical structure. Additionally, or alternatively, with software, selected functions of the invention could be performed by a data processor, such as a computing platform, executing software instructions or protocols using any suitable computer operating system.

### BRIEF DESCRIPTION OF THE DRAWINGS

The embodiments are herein described, by way of example only, with reference to the accompanying drawings. No attempt is made to show structural details of the embodiments in more detail than is necessary for a fundamental understanding of the embodiments. In the drawings:

FIG. 1 illustrates the auditory piece “Mary Had A Little Lamb”, played by pronouncing various series of phonemes;

FIG. 2 illustrates two melody structures featuring a 2̂n schema;

FIG. 3 illustrates one embodiment of a method for composing an auditory piece;

FIG. 4A illustrates a schematic block diagram of a device for playing auditory pieces;

FIG. 4B illustrates a schematic block diagram of a device utilized to drive auditory pieces into an audio system;

FIG. 5 illustrates one method;

FIG. 6 illustrates one example;

FIG. 7 illustrates a few alternative embodiments for measuring parameters related to infant development, reaction, activities, satisfaction, health, and more;

FIG. 8 illustrates a few examples of stimulating an infant to develop additional phonetic categories according to estimated development;

FIG. 9 illustrates one method for updating the auditory piece according to infant auditory environment;

FIG. 10 illustrates one embodiment for creating an auditory piece;

FIG. 11 illustrates a GUI including a two dimensional cross-section and the user's infant photo;

FIG. 12 illustrates a GUI including an ultrasound image of the user's embryo;

FIG. 13 illustrates a GUI including a photo placeholder and no record button;

FIG. 14 illustrates a method for assisting a user in recording at least one phoneme, quickly and accurately;

FIG. 15 illustrates a method for recording phonemes in infant-directed speech;

FIG. 16 illustrates one example of a method;

FIG. 17 illustrates one method for updating the auditory piece according to infant illness;

FIG. 18. illustrates a method for creating auditory pieces; and

FIG. 19. illustrates a method for processing recorded phonemes to auditory pieces.

### DETAILED DESCRIPTION

In the following description, numerous specific details are set forth. However, the embodiments of the invention may be practiced without these specific details. In other instances, well-known hardware, software, materials, structures and techniques have not been shown in detail in order not to obscure the understanding of this description. In this description, references to “one embodiment” or “some embodiments” mean that the feature being referred to is included in at least one embodiment of the invention. Moreover, separate references to “one embodiment” or “some embodiments” in this description do not necessarily refer to the same embodiment. Illustrated embodiments are not mutually exclusive, unless so stated and except as will be readily apparent to those of ordinary skill in the art. Thus, the invention may include any variety of combinations and/or integrations of the embodiments described herein. Also herein, flow diagrams illustrate non-limiting embodiment examples of the methods, and block diagrams illustrate non-limiting embodiment examples of the devices. Some operations in the flow diagrams may be described with reference to the embodiments illustrated by the block diagrams. However, the methods of the flow diagrams could be performed by embodiments of the invention other than those discussed with reference to the block diagrams, and embodiments discussed with reference to the block diagrams could perform operations different from those discussed with reference to the flow diagrams. Moreover, although the flow diagrams may depict serial operations, certain embodiments could perform certain operations in parallel and/or in different orders from those depicted. Moreover, the use of repeated reference numerals and/or letters in the text and/or drawings is for the purpose of simplicity and clarity and does not in itself dictate a relationship between the various embodiments and/or configurations discussed.

The term infant-directed speech may also be referred to as infant-directed talk, motherese, parentese, baby talk, mommy talk, or caretaker speech. Infant-directed speech is usually delivered with a “cooing” pattern of intonation different from that of normal adult speech: high in pitch, with many glissando variations that are more pronounced than those of normal speech. In some cases, infant-directed speech may also be characterized by the shortening and simplifying of words. It is known that in some cases infants prefer infant-directed speech over adult-directed speech, and are more emotionally responsive to infant-directed speech than adult-directed speech. Examples of infant-directed speech preference are summarized at page ii, in the Master of Science by Wendy L. Ostroff, titled “The Perceptual Draw of Prosody: Infant-Directed Speech within the Context of Declining Normative Phoneme Perception”, 1998, which is incorporated herein by reference in its entirety.

The term “music notation” or “musical notation” denotes any system that represents auditory stimuli. A single musical symbol, or a note, may denote both pitch and duration, and a string of musical symbols may notate both melody and rhythm. One or more notes may be moved up or down in pitch using transposition.

The term “auditory piece” denotes: (i) auditory data featuring a musical structure, (ii) one or more phonemes, (iii) other musical sounds such as beat, or (iv) any combination thereof. Examples of auditory pieces include, but are not limited to, very short to very long portions of a musical piece, a song, an entire musical piece or song, a phoneme, two or more instances of one or more phonemes, two or more instances of one or more phonemes accompanied by music, two or more instances of one or more phonemes that are recited according to a melody, two or more instances of one or more phonemes according to a beat, two or more instances of one or more phonemes in different pitches.

The terms “pronouncing” and “reciting” as used herein include, but are not limited to, singing, speaking, declaiming, articulating, and/or vocalizing.

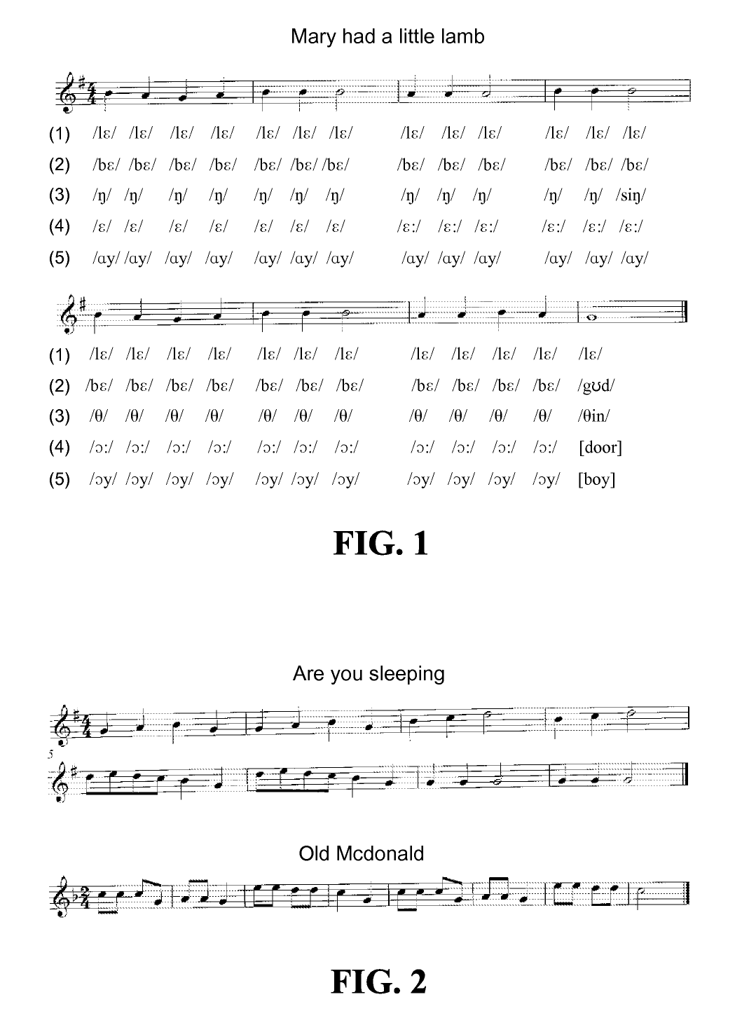

FIG. 1 illustrates the auditory piece “Mary Had A Little Lamb”, played by pronouncing various series of phonemes, in accordance with some embodiments. Optionally, the phonemes are played in a parent's voice. Alternatively, the phonemes are played in a voice other than the parent's voice. As illustrated, the auditory piece may be played by reciting a series including the same phoneme (1), a series including the same phoneme and one or more words (2), a series including a few phonemes and a few words (3), a series including short vowels, long vowels, and a word (4), and a series including diphthongs, and a word (5). The auditory piece may include one or more vowels, consonants, syllables, phonemes, diphthongs/digraphs/trigraphs, and/or other sounds. In some embodiments, the series of phonemes may include at least some phonemes that are repeated only once, phonemes having a lexicographic meaning, phonemes in one or more predetermined languages, or any other required combination. In some embodiments, positive suggestion sentences may be embedded in the auditory piece between the phonemes. It is to be understood that the auditory piece may also include phonemes without melody. For example, at least some phonemes may be played in the same pitch.

In some embodiments, the auditory piece may include a melody that is pleasant to the parent's ears and phonemes that the infant's parents find hard to pronounce. For example, Japanese people find it hard to pronounce ‘L’ and ‘R’. Therefore, a Japanese auditory piece may include a known Japanese melody with ‘L’ and ‘R’ phonemes. In one embodiment, the auditory piece includes a section of a known melody, or an entire known melody, and at least three successive repetitions of each phoneme.

In some embodiments, the series of phonemes include different phonemes arranged: (i) in alphabetical order; (ii) according to phonetic families, such as /BA/, /BE/, /BI/, /BO/, /BU/; (iii) according to a theory describing language skills development; (iv) according to a speech therapy report that may be customized to the specific infant; (v) as a series of phonemes synchronized with the melodic sentences; (vi) according to meaningful linear combinations of properties associated with sound; and/or (vii) certain repetitions of vowels and/or consonants conveying a meaning.

In some embodiments, the melody structure is a natural schemata, a learned schemata, and/or a 2̂n schema. FIG. 2 illustrates two melody structures featuring a 2̂n schema.

While growing, the infant passes through various developmental stages. Different developmental stages require different auditory pieces with different characteristics and containing a different mixture of phonemes.

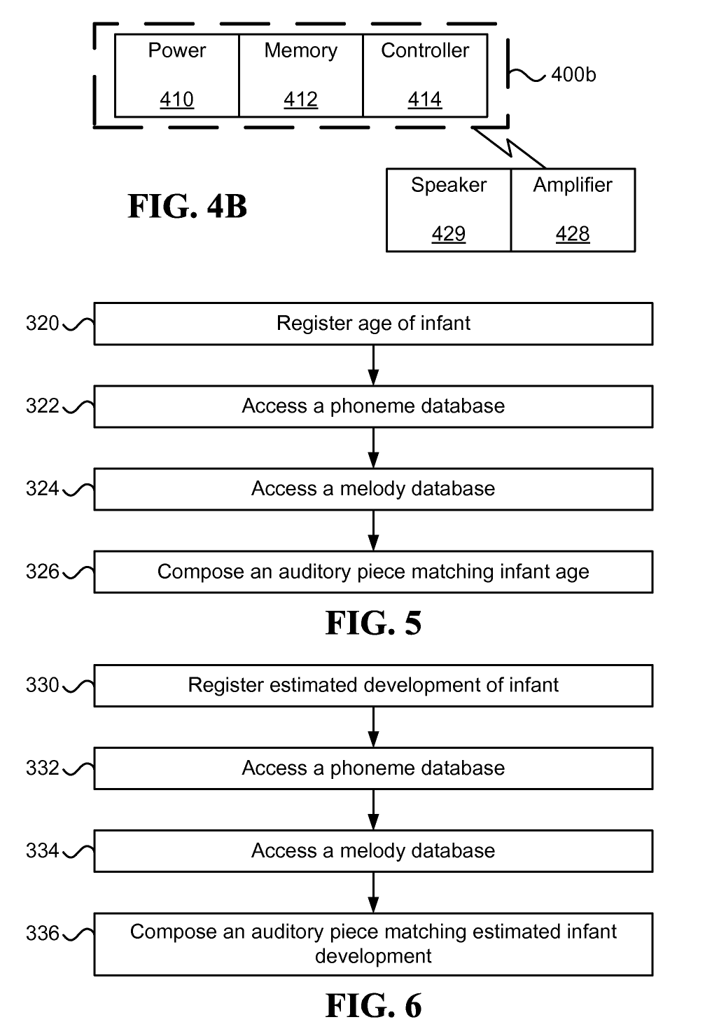

FIG. 4A illustrates a schematic block diagram of a device 400 for playing auditory pieces. The device 400 may include one or more of the following elements: a power source 410; a volatile and non-volatile memory 412; a controller 414; a speaker 416; a user interface 418; a communication element 420; a sensor 422 or an interface to an external sensor, such as a weight sensor, an electro optics sensor, or a sound sensor; a housing 424, and a microphone 426. The device 400 may have many configurations, including different combinations of the above described components, and additional optional components.

FIG. 4B illustrates a schematic block diagram of a device 400b utilized to drive auditory pieces into an audio system. The device 400b may include a power source 410, a memory 412, and a controller 414. The audio system may include an amplifier 428, and a speaker 429.

Language Skill Development According to Infant Age

In some embodiments, the age of the infant is entered into the device/software, calculated from some available data, estimated based on the time of operation and/or ordering of the device, and/or obtained or stored using any other appropriate method.

In one embodiment, auditory pieces appropriate to the different ages are prepared in advance. Then, the appropriate auditory pieces are played, according to the infant's age. For example, the device may play different tracks/files in different ages.

In another embodiment, the various phonemes, with or without optional combinations, are prepared in advance. Then, the required auditory pieces are created in advance for the various ages, from the available recordings.

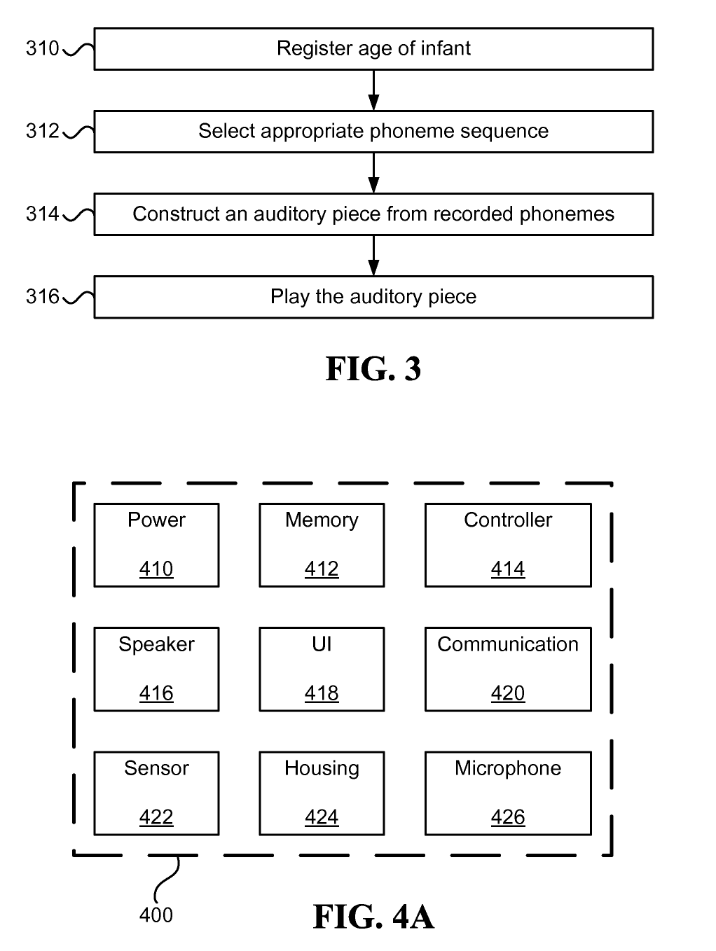

FIG. 3 illustrates one embodiment of a method for composing an auditory piece, including the following steps: In step 310, registering the infant age. In step 312, selecting a phoneme sequence appropriate to the infant's age. Optionally, most of the phoneme sequence may be without lexicographic meaning. In step 314, accessing a plurality of recorded phonemes and constructing an auditory piece from the recorded phonemes. And in step 316, playing the auditory piece. Optionally, at least some of the recorded phonemes are in the infant's parent's voice. Optionally, the auditory piece is composed according to a predefined melodic pattern.

The following three examples describe different optional phoneme mixtures.

A first example of phoneme mixture in an auditory piece, according to infant's age, includes: (i) until the age of about 4 months, mainly vowels; (ii) from about 4 to 8 months, vowels and consonants; and (iii) after the age of about 8 months, mainly consonants. The device may obtain the age of the infant and determine the mixture of vowels and consonants according to the age of the infant. In one embodiment, the mixture of vowels and consonants, and, optionally, the sound volume of each one of them, is a function of the age of the infant, so that the auditory piece is coordinated with the processes occurring in the infant's brain.

A second example of phoneme mixture in an auditory piece, according to infant's age, includes: (i) until the age of about 4 months, mostly vowels; (ii) from about 4 to 6 months, vowels, consonants, and diphthongs; (iii) from about 6 to 8 months, mostly consonants and diphthongs; some syllables containing vowels and consonants; and (iv) after about 8 months, mostly consonants and syllables containing vowels and consonants.

A third example of phoneme mixture in an auditory piece, according to infant's age, includes: (i) Until the age of about 3 months, mostly vowels; (ii) from about 3 to 4 months, more vowels than consonants and diphthongs; (iii) from about 4 to 5 months, vowels, consonants and diphthongs; (iv) from about 5 to 6 months, more consonants and diphthongs than vowels; (v) from about 6 to 7 months, more consonants than diphthongs and vowels; (vi) from about 7 to 8 months, consonants and some diphthongs and syllables containing vowels and consonants; (vii) from about 8 to 9 months, consonants and syllables containing vowels and consonants; (viii) from about 9 to 10 months, consonants, syllables containing vowels and some short words; (ix) from about 10 to 11 months, consonants, syllables containing vowels and short words; and (x) from about 11 to 12 months, syllables containing vowels and short words.

It is to be understood that other mixtures of phonemes, syllables, and/or words may be created as needed and according to the results of certain theories and/or experiments.

The melody of the auditory piece may also change according to the infant's age. For example, until the age of about 6 months, the infant is mostly influenced by intonation, while after about 6 months the infant begins searching for meaning. Therefore, the melody played until the age of about 6 months may feature a higher mean frequency, a higher pitch range, and/or a longer duration in relation to the melody played after about 6 months in age. Optionally, the melody played after the age of 6 months features a more complex structure, such as a longer musical phrase, and/or more tones. Optionally, from the age of 6 months, the infant is exposed to more stimulations, such as lights, images, and/or mechanical feedback, such as caressing.

FIG. 5 illustrates one embodiment including the following steps: In step 320, registering the infant's age, such as receiving the age from the parent. In step 322, accessing a phoneme database. Optionally, the phonemes are recorded in the infant's parent's voice. In step 324, accessing a melody database. And in step 326, composing an auditory piece that comprises at least one of the phonemes and one melody, and matches the infant's age.

In one embodiment, the system receives the infant's age (e.g., 4 months) and selects the content and volume of the auditory pieces accordingly. For example, for an infant under 6 months of age, playing relatively more vowels than consonants, quite slowly, at a primary, predefined sound volume. For an infant between 6 to 8 months old, playing relatively the same number of consonants and vowels, somewhat faster, at a secondary predefined sound volume. For an infant over 8 months of age, playing relatively more consonants than vowels, in a faster tempo, and at a third predefined sound volume.

In one embodiment, the playing order may be preprogrammed. For example, the parent's voice in English may be played during the first week, and then in French during the next week. As another example, a first piece may be played between the age of 4 to 8 months, a second piece between 8 to 12 months, a third piece between 12 to 20 months, and a fourth piece after 20 months.

Language Skill Development According to Infant Development

In one embodiment, the loudness and/or the content of the infant's babbling indicate her development, and therefore may determine the mixture of phonemes to be played. In one embodiment, the infant's weight indicates her development and/or her age, and therefore may determine the mixture of phonemes to be played. Statistical tables may be used for assessing the infant's development by weight and/or age. In one embodiment, the mixture of the phonemes to be played is determined according to the time of playing of the auditory pieces.

In one embodiment, the development of the infant is estimated by measuring infant activity. Examples of infant activity include movements, babbling, and sucking on a pacifier. In one embodiment, as the infant moves more strongly and/or rapidly, then the auditory piece is played louder and/or at a faster rhythm.

In one embodiment, an image-processing system is used to estimate the infant's volume. In one example, the image processing system utilizes an infrared sensor and, optionally, a distance-measuring component to translate the angular aperture to size.

In one embodiment, the infant's development is estimated by measuring the infant's brain waves, optionally while hearing an auditory piece.

FIG. 6 illustrates one example including the following steps: In step 330, registering the infant's estimated level of development. In step 332, accessing a phoneme database. Optionally, the phonemes are recorded in the parent's voice. In step 334, accessing a melody database. And in step 336, composing an auditory piece that comprises at least one of the phonemes and one melody, and matches the infant's estimated level of development.

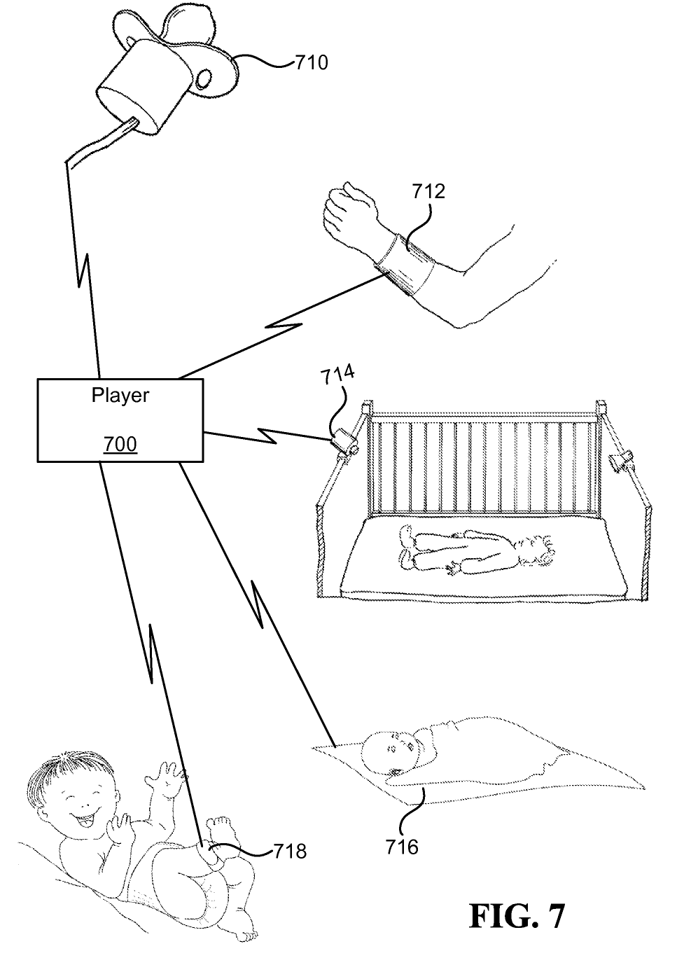

FIG. 7 illustrates a few alternative embodiments for measuring parameters related to infant development, reaction, activities, satisfaction, health, and more. For example, the player 700 may play audio pieces according to measurements received from a pacifier 710, a hand bracelet 712, a camera 714, a measuring mattress, and/or a leg bracelet.

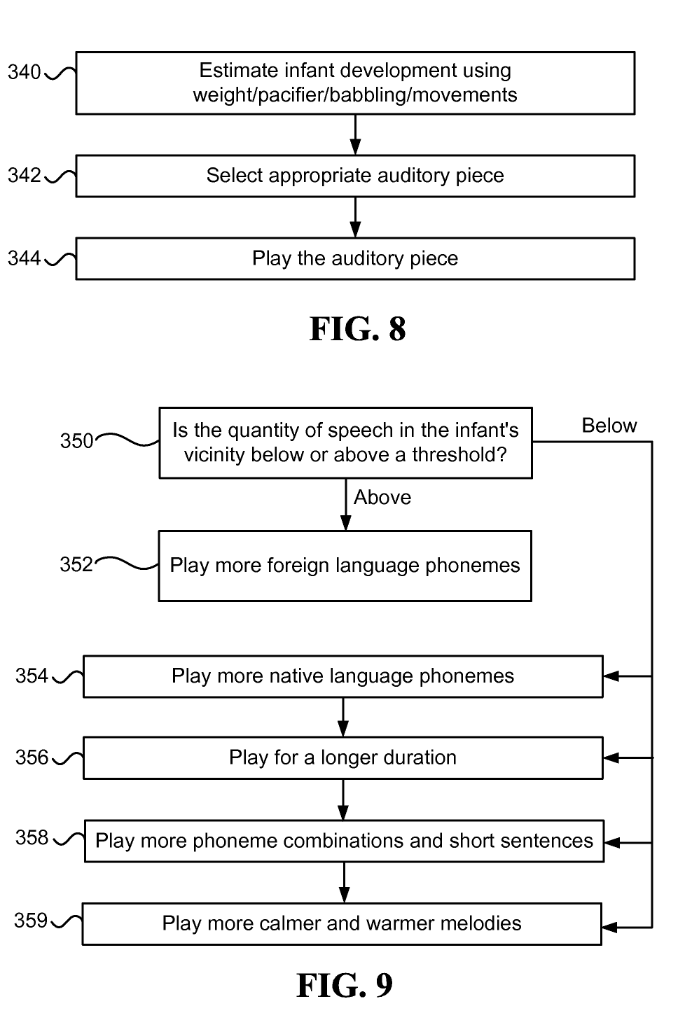

FIG. 8 illustrates a few examples of stimulating an infant to develop additional phonetic categories according to her estimated development, including the following steps: In step 340, estimating the development of the infant using one of the elements described herein, such as a weight sensor, an electronic pacifier, babbling audio processing module, and/or a movement sensor worn by the infant or placed in the infant's vicinity, such as under the infant's mattress. In step 342, selecting an auditory piece appropriate to the estimated development; optionally, the auditory comprises isolated phonemes in the parent's voice. And in optional step 344, playing the auditory piece.

In one embodiment, the auditory piece is played when it is estimated that the infant is relatively calm. Optionally, the volume and/or the melody may be set according to the level of calmness of the infant. The level of calmness may be estimated using almost any appropriate method, such as disclosed in US patent application number 20090018421, which is incorporated herein by reference.

In some embodiments, the teachings of some of the following references may be utilized to monitor an infant; to analyze when an infant understands something, tries to communicate, concentrates; to measure the infant's mental condition, state of mind, mood, comfort, level of stress, and physical state. Some embodiments may measure the infant's facial expressions, sucking parameters, physical motions, sounds, and/or biometrics, such as heartbeat, breathing rate, body temperature, sweat, and/or electrical brain response. Some measurements, such as smiling and cooing, may indicate that the infant is satisfied or happy with the current environmental and/or bodily conditions, or indicate understanding of speech or sound she hears. Other signals, such as crying, may indicate dissatisfaction.

In some embodiments, an infant's non-nutritive sucking parameters are detected using an electronic pacifier. For example, US patent Application No. 20080077183, entitled “Well-being of an infant by monitoring and responding to non-nutritive sucking”, which is incorporated herein by reference, describes an electronic pacifier.

In some embodiments, infant babbling is detected using a voice detection element. For example, U.S. Pat. No. 5,964,593, entitled “Developmental language system for infants”, which is incorporated herein by reference, describes a computer toy for infants to promote normal speech development.

In some embodiments, infant babbling is recorded, catalogued, and analyzed. For example, US patent Application No. 20080096172, entitled “Infant Language Acquisition Using Voice Recognition Software”, which is incorporated herein by reference, describes speech analysis software.

In some embodiments, infant bodily movements and babbling are sensed using a video camera and a microphone. A computer may generate response to the bodily movement or babbling. For example, U.S. Pat. No. 6,517,351, entitled “Virtual learning environment for children”, which is incorporated herein by reference, describes a camera-based responding system.

In some embodiments, an infant's physical movements are measured using a blanket with a plurality of actuator elements that are selectively responsive to physical movement of the infant, and, optionally, with an audiovisual output device for providing feedback. For example, U.S. Pat. No. 5,260,869, entitled “Communication and feedback system for promoting development of physically disadvantaged persons”, which is incorporated herein by reference, describes a measuring blanket.

In some embodiments, infant brain response to sound is tested by sensing the brain's electrical activity. For example, US patent Application No. 20050018858, entitled “A rapid screening, threshold, and diagnostic tests for evaluation of hearing”, which is incorporated herein by reference, describes brain wave testing.

In some embodiments, an infant's motions are measured using a wireless bracelet device. For example, PCT publication No. WO2008079296, entitled “Apparatus and method for wireless autonomous infant mobility detection, monitoring, analysis and alarm event generation”, which is incorporated herein by reference, describes a wireless bracelet.

In some embodiments, an infant's breathing and movements are measured through the mattress. For example, U.S. Pat. No. 5,271,412, entitled “Movement detector and apnea monitor including same”; U.S. Pat. No. 6,652,469 entitled “Movement detector pad with resilient plate attachment”; and U.S. Pat. No. 5,448,996 entitled “Patient monitor sheets”, which are incorporated herein by reference, describe movement sensors.

Language Skill Development According to Infant Health or Environment

Some studies indicate that if an infant had a hearing problem while the brain created the phonetic categories, for example between the age of 4 to 8 months, then the child's phonetic awareness to its native language and to foreign languages may decrease, and optionally result in writing problems and learning disabilities. The following embodiments describe some optional adjustments to deal with the hearing problem.

In one embodiment, the system receives data about the hearing-related problem, such as otitis, runny nose, or fluids in the hearing system, and adjusts its operation accordingly. Examples of operation adjustments include, but are not limited to: (i) Adjusting the playing volume. Optionally, the volume of playing is determined according to the hearing-related problems. For example, if the infant suffers from otitis, the system will play the auditory pieces louder so that the infant will hear. The hearing problem may be temporary or constant and the system may consider this when determining the sound volume and, optionally, the content to be played. (ii) Adjusting the phoneme mixture. For example, the longer the otitis lasts, the higher the percentage of the native language phonemes. As another example, if a first set of auditory pieces was not played enough because the infant was sick, play the first set for a longer duration, and possibly instead of some of the subsequent phoneme set(s). (iii) Adjust the feedback mechanism and/or interactive mechanism(s). For example, during operation the auditory piece may be accompanied with light, while during an illness, the light may not be operated at all or may be operated less. Alternatively, if the baby cries often, more lights may be operated in order to divert the infant's attention from the pain. (iv) Adjusting the melody. For example, an infant suffering from otitis may be exposed to auditory pieces at a lower tempo, and/or the time gap between consequent phonemes may be increased. (v) Adjusting the sounds accompanying the phonemes and/or filtering out problematic frequencies. For example, for an infant experiencing tympanic membrane problems, causing him pain when hearing certain frequencies, the system filters out the problematic frequencies. Alternatively, the system may transpose the auditory piece such that it will not contain the problematic frequencies. For example, an infant with problems in frequencies higher than about 1000 Hz will be supplied with auditory pieces containing frequencies below about 950 Hz. This may be accomplished by filtering out the problematic frequencies, transposing the entire auditory piece to the required frequency band, or using other recordings. And/or (vi) Adjusting operational parameter(s). For example, changing the threshold to stop or alter the playing upon crying or stress indicates when the infant is sick and/or having hearing problems.

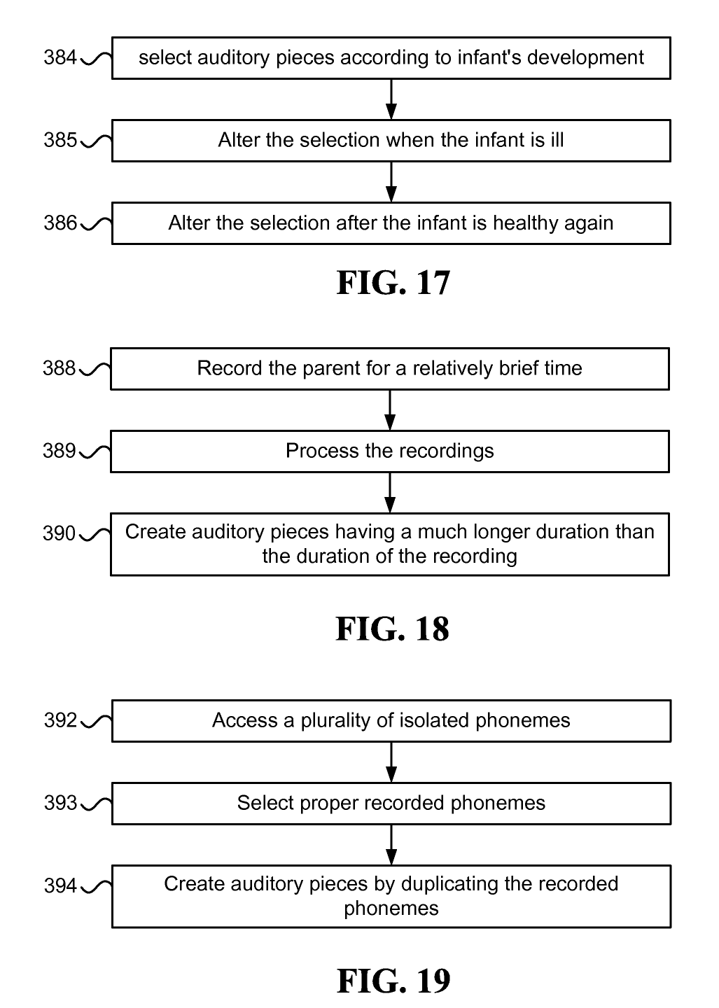

FIG. 17 illustrates one method for updating the auditory piece according to infant illness. In step 384, selecting the auditory pieces according to the infant's estimated development. In step 385, altering the selection when registering that the infant is ill. And in step 386, altering the selection after the infant is healthy again. Optionally, the illness comprises a hearing problem and the indication comprises the duration of the hearing problem. Optionally, altering the selection comprises changing the mixture of phonemes, changing the melody, and/or altering of the operation of visual indication operated with the auditory pieces.

In one embodiment, when the infant recovers from otitis, she may still have fluids in the hearing system that will dull her hearing. The system may take this into account and continue to compensate for the hearing problem even after the system receives indication that the infant has probably recovered from the otitis.

In one embodiment, the compensation includes one or more of the following: playing louder, providing special content, or playing phonemes that are more distinct so that the infant will be able to distinguish between the different phonemes.

In one embodiment, the auditory piece played to an infant with past or present hearing problems has slower tempo and the phonemes are clearer and more distinct with comparison to the auditory piece played to a healthy infant.

In one embodiment, the mixture of phonemes is modified. For example, an infant of normal health at the age of 4 to 6 months may be exposed to a phoneme mixture having more vowels than consonants, and at the age of 6 to 8 months a phoneme mixture having more consonants than vowels; while an infant suffering from otitis at the age of 4 to 6 months may be exposed at the age of 6 to 8 months to a phoneme mixture of about 50% vowels and 50% consonants.

In one embodiment, the system comprises a sensor for monitoring the infant's behavior. Examples of sensors for monitoring behaviors include: a movement sensor for detecting nervousness or happiness, for example; a sound sensor for detecting crying, nervousness, calmness, or happiness, for example; and/or a camera with image processing sensor, or movement sensor.

The monitored infant's behavior is analyzed to detect hearing problems, preferred auditory pieces, preferred playing levels, or other characteristics of the system. Then the system can automatically alter its operation according to the analysis result. For example, if the system measures that the monitored infant sleeps better when playing at a low sound level or while playing the mother's voice, comparing to when playing louder or while playing the father's voice, the system may decrease the playing volume or play more pieces in the mother's voice while the infant sleeps.

Alternatively, the system may forward the measurements to a supervisor. The notification may include a recommendation for further actions. For example, if the system measures the monitored infant making irregular movements while hearing a certain frequency band, the system may notify a supervisor that the infant may have hearing problems, making him susceptible to the problematic frequency band.

FIG. 9 illustrates one method for updating the auditory piece according to infant auditory environment. In step 350, registering a measurement of the quantity of speech in the infant's vicinity and checking to see if it is below or above a predefined threshold. In step 352, playing more foreign language phonemes if above the threshold, and, if below the threshold, playing one or more of the following optional steps: In step 354, playing more native language phonemes. In step 356, playing the auditory pieces for a longer duration. In step 358, playing a mixture including more phoneme combinations and optionally brief sentences. In step 359, playing calmer and warmer melodies.

In one embodiment, the device—which may be a software, here as well as in all other relevant places in this description—receives an indication of whether the infant's parent is deaf or having pronunciation problems. If the parent has problems with specific phonemes, these phonemes may be repeated more often than usual. If the mother cannot successfully record certain phonemes in her native language, she may have problems with this phoneme, and that phoneme may be played more often than usual.

Using Infant's Parent's Voice for Developing Phonetic Categories

In some embodiments, it is advantageous to have the auditory pieces recited to the infant using a specific voice. Examples of specific voices include, but are not limited to: the voice of the infant's parent(s), the voice of the infant's relative(s), such as brother/sister, grandfather/grandmother, friend, or the voice of a third party that has the infant parents' respect or love. Usually, the infant is more attentive to the voice of her mother than to other voices. Therefore, playing the auditory pieces in the infant mother's voice provides an unexpected result that in some cases cannot be obtained from similar auditory pieces that are not in the infant mother's voice.

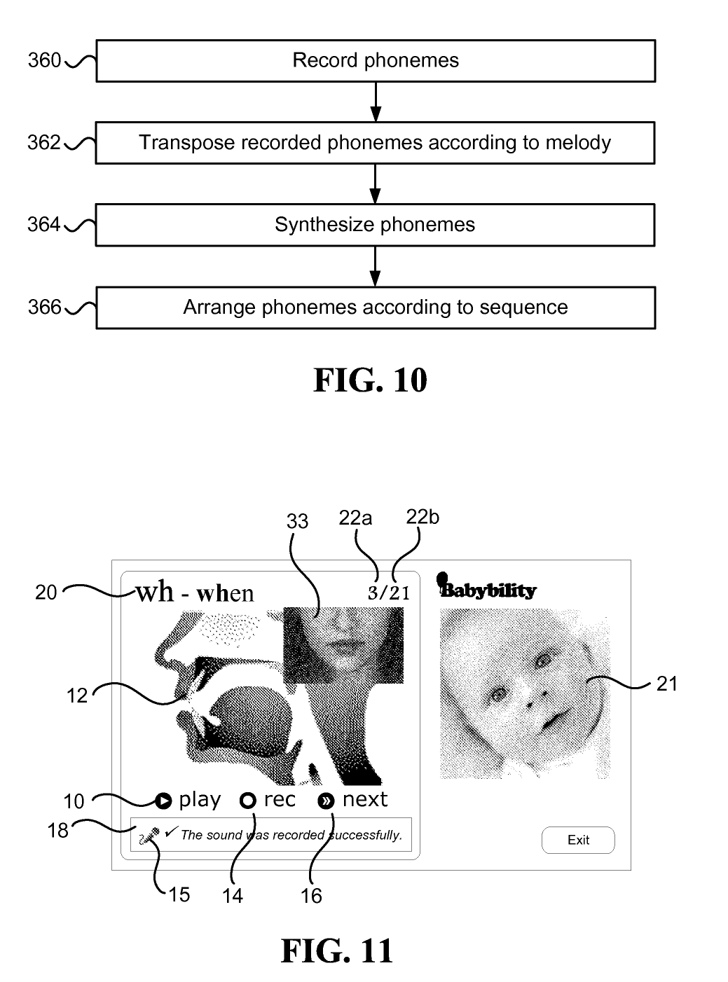

The auditory piece may be created from the recorded phonemes using a variety of methods, such as the following. In one embodiment, the user records all phonemes. Alternatively, the user records the distinct phonemes in all the required pitches. Then the recording is processed to create the auditory pieces. In one embodiment, the auditory piece is created using the following method: recording one or more phonemes; transposing the recorded phonemes according to a predefined melody, and arranging the transposed phonemes according to a predefined sequence. Optionally, the melody is selected from a predefined group. Optionally, the sequence is selected by the user. Optionally, the phonemes include at least one instance of each vowel and consonant that are common in a predefined language. FIG. 10 illustrates one embodiment for creating an auditory piece. In step 360, recording one or more phonemes; in step 362, transposing the recorded phonemes according to a predefined melody; in step 364, synthesizing one or more phonemes; in step 366, arranging the transposed and synthesized phonemes according to a predefined sequence. Optionally, the synthesized phonemes belong to a foreign language. Optionally, the synthesized phonemes are phonemes that the user cannot pronounce or did not pronounce correctly.

In one embodiment, the auditory piece is created from the recorded samples using one or more of the following methods: (i) Combining different voice samples (without transposition). (ii) Obtaining transposed voice samples and combining the original voice samples and the transposed voice samples into the auditory piece. Or (iii) Synthesizing one or more phonemes from the recorded phonemes.

In one embodiment, the recorded samples are tuned to the required properties. In one embodiment, additional sounds are synthesized based on the recorded samples. Optionally, the recorded, tuned, and/or synthesized sounds are mixed together to create one auditory piece.

In one embodiment, the auditory piece is constructed from the recorded, tuned, and/or synthesized sounds using predefined commands and/or sound processing tools. Optionally, the samples are provided to a sound technician in such a way that will enable him to produce the auditory piece efficiently,

In one embodiment, in order to compose the auditory piece in a voice similar to the user's voice, the software learns the voice characteristics of the user and uses those characteristics for composing the auditory piece. Examples of voice characteristics include, but are not limited to, characteristic frequencies and amplitudes, characteristic harmonics, or a variety of models. U.S. Pat. No. 7,168,953, entitled “trainable videorealistic speech animation”, which is incorporated herein by reference for all that it teaches. As a result of learning the user's voice characteristics it is possible to compose auditory pieces comprising phonemes that were not previously recorded by the user. Optionally, it is also possible to process phonemes into words and sentences.

In one embodiment, in order to compose the auditory piece in a voice similar to the user's voice, the software learns the voice characteristics of the user and then selects a similar voice from a prerecorded database containing a plurality of voices having different characteristics. Optionally, the result may be a combination of more than one voice. For example, voice A may be used for the vowels and voice B for the consonants. As a result, it is possible to compose auditory pieces comprising phonemes that were not previously recorded by the user. This method makes it possible to create audio books, television shows and/or learning materials in a voice similar to the required voice.

In one embodiment, the user records two or more variations of the same sound. Each variation may have a different duration, pitch, and/or feeling. In one embodiment, echo, sustaining, and/or other auditory effects are applied to the recorded sound in order to create additional variations. Different versions of the same sound may be used for different auditory pieces.

In one embodiment, different auditory pieces are created by changing the pitch, duration, and/or amplitude of the recorded samples. For example, the beginning of an auditory piece playing the same sound may be louder than the ending of that auditory piece.

The following 3 examples describe options to create a variety of auditory pieces using the same parent recordings.

(i) It is possible to construct numerous auditory pieces using a single recording of a set of phonemes. For example, a parent may record phonemes, obtain a first set of auditory pieces, and, when the infant grows and if the parent is satisfied, obtain a second set of auditory pieces without having to undergo another recording session.

(ii) Once the parent records the basic phoneme set, the parent may order any number of auditory pieces. From time to time, the parent may review the available auditory pieces and order additional auditory pieces, optionally, without having to undergo another recording session.

(iii) If two or more people record the basic set of phonemes, it is possible to order different auditory pieces in different voices. For example, the first two auditory pieces may be in the mother's voice and the other two auditory pieces may be in the father's voice. In one embodiment, certain phonemes are synthesized from the recorded phonemes.

In one embodiment, while or after the user records a phoneme, the sampling assistant software indicates whether the duration of the phoneme is within the required interval. Optionally, the parent records some phonemes having at least two different durations, and the software verifies the durations. Alternatively, the different durations are created synthetically.

Tonal languages convey information in pitch changes. In one embodiment, the auditory piece includes phonemes in different pitches, and/or phonemes with various glissandi. Optionally, a visual or mechanical indication accompanies the pitch change. For example: (i) Moving an object, such as a doll or an image in relation to the pitch. e.g., the higher the pitch, the higher the doll. (ii) Adding lights. And optionally changing color, intensity, or operating different light sources. (iii) Changing images displayed on a screen. (iv) Connecting the pitch to the height of a hammock. e.g., the higher the infant, the higher the played pitch, and vice versa.

In one embodiment, a method for creating auditory pieces to be played to an infant for stimulating the development of phonetic categories, including the following steps: recording a plurality of isolated phonemes by the infant's parent. And, processing the recorded phonemes to enable the playing of auditory pieces comprising the isolated recorded phonemes, wherein the total duration of the different auditory pieces is at least three times longer than the total duration of time invested by the parent in the recordings. Optionally, the auditory pieces comprise melodies, and/or phonemes in pitches, which were not originally recorded by the parent. Optionally, the auditory pieces include isolated phonemes. Optionally, the recorded phonemes are transposed. Optionally, new phonemes are synthesized from the recorded phonemes. Optionally, each phoneme has a predefined duration interval, and the method tests whether the duration of the recorded phonemes maintains the predefined duration.

FIG. 18. illustrates a method for creating auditory pieces to be played to an infant for stimulating the development of phonetic categories, including the following steps. In step 388, recording the infant's parent for a relatively brief time. In step 389, processing the recordings. And in step 390, creating auditory pieces having a much longer duration than the duration of the recording. Optionally, the parent uses infant-directed speech.

FIG. 19. illustrates a method for processing recorded phonemes to auditory pieces, including the following steps. In step 392, accessing a plurality of isolated phonemes recorded by a plurality of users. In step 393, for each user, selecting the proper recorded phonemes. And in step 394, creating auditory pieces by duplicating the recorded phonemes. Optionally, the step of creating the auditory pieces includes processing at least some of the phonemes. Optionally, processing the phonemes includes changing the pitch of at least one of the phonemes.

In one embodiment, a method for creating auditory pieces to be played to an infant for stimulating the development of phonetic categories, comprising: recording a plurality of isolated phonemes by the infant's parent; and processing the recorded phonemes to enable the playing of auditory pieces comprising the isolated recorded phonemes; wherein the total duration of the different auditory pieces is at least three times longer than the total duration of time invested by the parent in the recordings. Optionally, the auditory pieces comprise melodies that were not originally recorded by the parent. Optionally, the auditory pieces comprise phonemes in pitches that were not originally recorded by the parent. Optionally, the step of processing the recorded phonemes further comprises creating auditory pieces comprising the isolated recorded phonemes, and/or transposing the recorded phonemes, and/or synthesizing new phonemes from the recorded phonemes. Optionally, each phoneme has a predefined duration interval, and further comprising the step of checking if the duration of the recorded phonemes maintains the predefined duration.

In one embodiment, a method for creating auditory pieces to be played to an infant for stimulating the development of phonetic categories, comprising: recording the infant's parent for a relatively brief time; processing the recordings; creating auditory pieces having a much longer duration than the duration of the recording. Optionally, the parent uses infant-directed speech. Optionally, the auditory pieces comprise melodies that were not originally recorded by the parent, and/or phonemes in pitches that were not originally recorded by the parent. Optionally, the step of processing the recording comprises synthesizing new phonemes from the recorded phonemes.

In one embodiment, a method comprising: accessing a plurality of isolated phonemes recorded by a plurality of users; for each user, selecting the proper recorded phonemes, and creating auditory pieces by duplicating the recorded phonemes. Optionally, the step of creating the auditory pieces comprises processing at least some of the phonemes. Optionally, processing the phonemes comprises changing the pitch of at least one of the phonemes.

The following non-limiting examples illustrate methods for indicating to the user which phoneme(s) to pronounce:

(i) Playing a phoneme/several phonemes/a word/a sentence, and the user repeats what she hears. Optionally, displaying the phonemes to be pronounced by the user and playing sound(s) in the required pitch and/or rhythm. The user pronounces the displayed phoneme/several phonemes/word/sentence in accordance with the played sounds. Optionally, playing samples before the user pronounces the required phoneme.

(ii) The user pronounces the phonemes to the beat of a metronome.

(iii) Playing a tuning sample and then the user pronounces the second time the tuning sample is played.

(iv) Playing a tuning sample and then the user imitates the tuning sample.

(v) Playing a tuning sample using a first voice, playing the same tuning sample using a second voice, and then recording the user with the second voice.

(vi) Playing a tuning sample, after which the user pronounces the phoneme with an instrumental accompaniment.

(vii) Playing a tuning sample, then playing a tuning chord, and then the user pronounces the phoneme with or without accompaniment.

(viii) Playing a tuning sample and then the user may select whether or not to play additional tuning samples and/or tuning chords. For example, the user may request a tuning chord every 5 phonemes. Optionally, the sampling assistant software determines whether to play the additional tuning samples and/or tuning chords. Optionally, playing the additional tuning samples and/or tuning chords according to the user's performances. For example, a user having difficulties will be provided with more additional tuning samples and/or tuning chords in relation to a user having fewer difficulties.

Vocal Tract Model to Assist a Parent in Recording an Isolated Phoneme

In some embodiments, in order to save the parents time, to increase the quality of the recordings, to enable cost-effective control over the recordings, and/or to industrialize the process, a sampling assistant software, which includes a cross-section animation, guides the parent in the voice sampling process (also referred to as the recording process) by indicating to the user the phonemes she has to pronounce and/or assisting the user with the phonemes. Using a cross-section animation may sometimes shorten the recording process significantly.

FIG. 11 illustrates one example of a two dimensional cross-section 12. The cross-section 12 animates the vocal tract movements. The GUI example of FIG. 11 also includes the following elements: a description of the phoneme to be recorded 20, the serial number of the current phoneme 22a with the total number of phonemes to be recorded 22b; a video of a person pronouncing the phoneme to be recorded 33, a play button 10, a record button 14, a next phoneme button 16, recording indication icon 15, a text box 18 for messages, and an infant image 21.

In one embodiment, there are two basic software structures. (i) The user records most or all of the different sounds included in the auditory pieces, or records the entire set of auditory pieces, optionally in sequence. (ii) The user records a set of phonemes that are processed to create the auditory pieces. For example, a software or a sound technician creates the auditory pieces using transposition, normalization, volume alignment, and/or phoneme synthesis. In both structures, the sampling assistant software may guide the user as to which phonemes to pronounce and how to pronounce them, and may optionally play a tuning chord before the user pronounces the required phoneme(s). Optionally, the pitch of all, some, or none of the recordings may be normalized.

In one embodiment, the user records an isolated phoneme, making it possible to show her the positions and movements of the elements in the vocal tract using an animated model. The animated model may include one or more of the following: a two-dimensional cross-section, a three-dimensional cross-section, a three-dimensional structure of the mouth, a partially transparent model, and a representation of the tongue's position. In one example, when the analysis determines that the user did not open his lips sufficiently, or did not place the tongue in the right position, the lips or tongue are marked to enable the user to improve.

In one embodiment, an auditory explanation of pronunciation is included in the guidance. For example, in order to pronounce ‘th’, please place your tongue between your front teeth.

In one embodiment, the user pronounces two or more phonemes, one after the other. Optionally, the guiding software plays the phonemes to be recorded and then the user repeats. Optionally, the user may repeat more times than the software plays. For example, the software plays /ε/, /ε:/ and the user pronounces /ε/, /ε/, /ε:/, /ε:/.

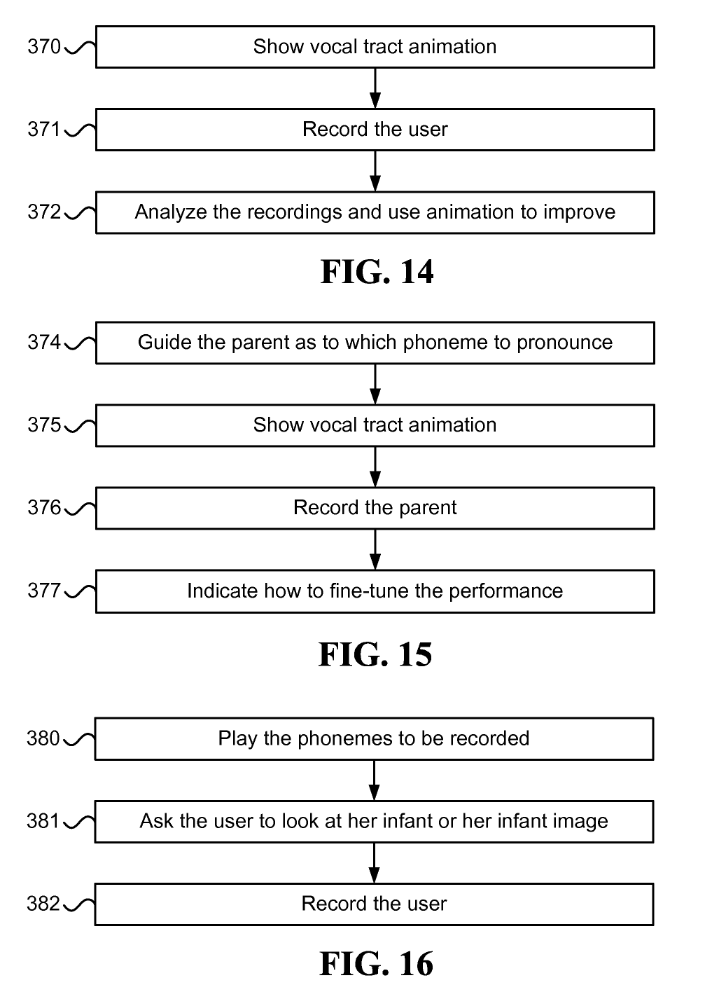

FIG. 14 illustrates a method for assisting a user in recording at least one phoneme, quickly and accurately, including the following steps: In step 370, showing the user an animation illustrating the movements in the vocal tract to pronounce the phoneme; and in step 371, recording the user. In optional step 372, analyzing the recordings and, when appropriate, using the animation for focusing the user on how to improve the next recording.

FIG. 15 illustrates a method for recording phonemes in infant-directed speech for stimulating an infant to develop additional phonetic categories, including the following steps. In step 374, guiding the infant's parent as to which phoneme to pronounce. In step 375, showing the parent an animation illustrating the movements in the vocal tract required to pronounce the phoneme. In step 376, recording the parent. And in step 377, indicating to the parent how to fine-tune her performance, such as duration, pitch, pitch variation, and/or volume.

In one embodiment, the following method steps are performed: (i) The user selects at least one language. (ii) According to the selected language, the sampling assistant software selects the required phonemes to be recorded. And (iii) The sampling assistant software guides the user in recording the required phonemes. For example, if the user selects English, the sampling assistant software will guide the user to pronounce and sample typical English phonemes, such as /BA/, /TH/, and /CH/. If the user selects English and Hebrew, the sampling assistant software will guide the user to pronounce and sample typical Hebrew throat consonants and typical English phonemes. (iv) Optionally, phonemes that the user cannot pronounce well are synthesized such that the phonemes of one language, or the well-recorded phonemes, are manipulated to create the phonemes of another language, or the phonemes that were not recorded properly. For example, the French vowels /E/, /O/, /A/, /U/, and /H/ may be synthesized from their related English vowels.

In one embodiment, a user may sample the phonemes she pronounces well and the rest are taken from a third party and/or from a database of prerecorded phonemes.

Optionally, the user records phonemes, and according to the recording results, one of the following voices is utilized to create the auditory piece: the user's voice, a synthesized voice based on the user's voice, and/or a third party's voice. Optionally, a threshold for determining if the user's voice quality is satisfactory is utilized.

In one embodiment, the user (for example, the infant's parent) would like to strengthen specific phonemes, for example, phonemes that are not pronounced well by the infant's parent, or phonemes that are important to a specific accent. The following are non-limiting examples of methods to emphasize specific phonemes: (i) increase the number of returns, (ii) play louder, or (iii) play different instances of the specific phonemes in different voices or using a different voice.

In one embodiment, while and/or after the user pronounces phonemes, the sampling assistant software analyzes the sample and may notify the user as to whether or not some parameters, such as the pitch, amplitude, and/or duration, are within the required range, whether the user pronounced the required phonemes successfully, and/or whether the environmental noise is acceptable. In case of problems, the user may be asked to rerecord specific phonemes.

In one embodiment, the pitches of the different samples should approximately match a predefined range. For example, a predefined set of phonemes should be in the similar pitch range. Optionally, the user is provided with an indication of whether the current pronunciation is too high or too low in pitch. Optionally, the recording software checks whether the current samples are aligned/match/coherent with the rest of the samples.

FIG. 13 illustrates a GUI which includes a tuning chord play button 10b, but does not include the record button 14. In this case, the software may record continuously, upon a measurement, or when not playing a tuning chord. This embodiment enables the user to record as soon as she thinks she can pronounce the phoneme correctly. The software knows when it played the tuning chord and thereby can easily separate between sounds played by the software and sounds pronounced by the user.

In one embodiment, the sampling assistant software helps people who lack musical talent and/or may pronounce off-key (inaccurate in pitch), to pronounce better, using one or more of the following methods: (i) provide vocal and/or visual feedback indicating up/down in pitch; (ii) play the auditory piece again; (iii) play another auditory piece(s) in the same pitch; and (iv) ask the user to pronounce the phonemes with the recording sample, and optionally subtract the recording samples from the recordings.

In one embodiment, the requirements from the sampled phonemes include, but are not limited to, the following parameters: pitch; rhythm; or sound wave structure, such as smoothness, minimum and maximum frequency components, noise electronic, and/or environmental noise.

In one embodiment, the sampling assistant software includes a training mode. The training mode explains to the user what is required and optionally checks the user's ability to pronounce the required phonemes. The user may be able to select which of the phonemes she wants to record by herself and the other phonemes will be recorded by someone else, taken from a database of prerecorded phonemes, or synthesized. Optionally, a short preliminary session is recorded in order to assess the user's quality of pronunciation. Non-limiting examples of training sessions include those with: only a portion of the easy-to-pronounce phonemes, fewer repetitions for each phoneme; and/or fewer phonemes, words, and/or combinations than included in the set of phonemes to be sampled for producing the required auditory pieces.

In one embodiment, before or while recording, the user is requested to record phonemes in a pitch that is comfortable for her. The user's comfort pitch zone may be determined by asking the user to say or sing something. Optionally, the user is requested to say or sing a known piece or say or sing a written text that is provided to him. The purpose of this step is to cause the user to sing in his natural pitch and therefore the system does not provide the user with an auditory example that might cause the user to sing in an unnatural or uncomfortable pitch. Then, the natural pitch is identified and the user is provided with phoneme samples having a similar pitch. For example, a low-pitch male may be provided with low-pitch phoneme samples, while a high-pitched woman may be provided with high-pitch phoneme samples. In one embodiment, the system registers the gender of the user to be recorded as input and provides male voice samples to men and female voice samples to women.

In one embodiment, after identifying the user's comfort pitch zone, the system transposes the phoneme samples to the user's comfort pitch zone, such that the user will be provided with guiding samples that are easy to repeat.

Different users may have different musical abilities, making it easier for some users to quickly and accurately pronounce the required phonemes, while others may find it difficult to pronounce them. Those who find the process difficult may require numerous tuning samples and may prefer reciting a plurality of phonemes each time rather than one or a few phonemes. In one embodiment, the sampling assistant software provides the user with a brief tuning sample. If the user pronounces the phoneme(s) well, the sampling assistant software continues to the next phoneme. Otherwise, the sampling assistant software presents the user with a longer tuning sample. If a user repetitively fails on the brief tuning samples, the sampling assistant software may proceed by presenting the user only with the longer tuning samples.

A non-limiting example of a series of tuning samples having progressively increasing/decreasing durations includes the following: (i) Two instances of a phoneme, wherein each instance is of different duration, such as a quarter note and a half note. (ii) Tuning sample with a duration of two measures. (iii) Tuning sample with a duration of four measures. (iv) Tuning sample with a duration of four measures and a different melody.

In one embodiment, the user indicates how much time she wishes to invest in the recordings. The longer the time, the more phonemes the sampling assistant software may present to the user to sample, optionally, in different pitches, rhythms, and/or combinations. Alternatively, the longer the time, the more repetitions of at least some of the phonemes may be presented to the user to sample.

There may be cases where it is required to encourage the user while recording. For example:

(i) Interactive game. The recording program is integrated with an interactive game and the user records the required phonemes while playing the game.

(ii) Competition recording game. The user competes against a virtual rival and/or against other users. Optionally, the user's score is calculated according to one or more of the following parameters: the quality of the samples, the speed at which the user records the required samples, the user's endurance, the amount of time the user invests in the sampling game, or the user's ability to repeat complicated phonemes and/or phoneme combinations. Optionally, the game encourages many people, optionally related to the infant, to record phonemes. For example, using the game, the infant may receive recordings of the parents and the brothers. Optionally, the phonemes having the highest quality are selected for the auditory piece.

(iii) In one embodiment, the parent obtains a score that calculates the “effectiveness” of the recording and compares it against a benchmark.

(iv) In one embodiment, the user is recorded, optionally in normal speech; the recordings are analyzed; and, based on the analysis, pre-existing professional recordings having similar sound characteristics are provided to the user. Alternatively, the recordings are enhanced using audio processing.

Infant Photo to Improve Infant-Directed Speech Recordings

For a long period, the inventors have been looking for a reliable and simple way to record infant-directed speech. While some parents have been able to pronounce good infant-directed phonemes and words while recording, there have been some parents who found it difficult to pronounce good infant-directed phonemes and words while recording. The inventors arrived at the conclusion that seeing the infant may help some parents to record good infant-directed speech. In some embodiments, the voice-recording solution comprises an image of the user's own infant.

Displaying an image of the user's own infant yields greater than expected results because some of the parents who previously were unable to pronounce good parentese phonemes and words, were able to pronounce good parentese phonemes and words while seeing an image of their own infant. Therefore, displaying an image of the user's own infant during the recording process shows an additive result when a diminished result is received with no image of the user's own infant.

The property of presenting an image of the user's own infant is not presented by the prior art voice-sampling solutions. Therefore, the disclosed voice-sampling embodiment, which displays the user's own infant image, is unexpectedly superior to the prior art when recording infant-directed speech.

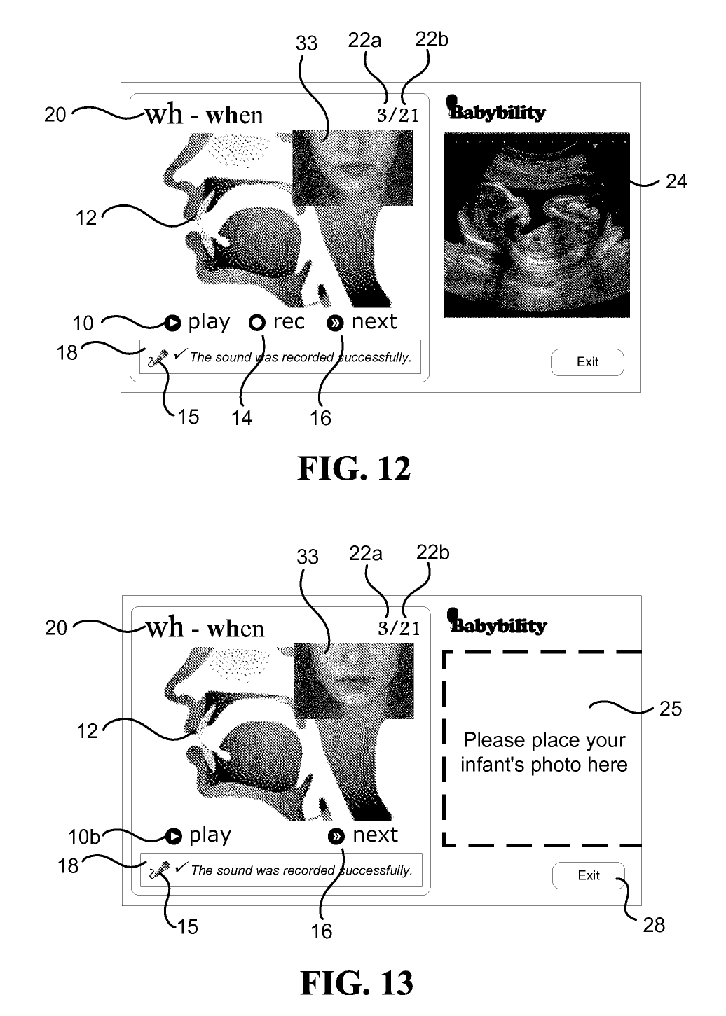

Some examples of infant images include: ultrasound image of the embryo, image of the infant, or image of a relative infant. FIG. 11 illustrates a GUI which includes an image of the user's infant 21. FIG. 12 illustrates a GUI which includes an ultrasound image of the user's embryo 24. It is to be understood that images 21 and 24 may be either static images or moving images.

In one embodiment, animation is added to the image of the infant to encourage the mother to speak in her infant-directed speech and provide her with feedback after a successful recording. For example, a portion of a 3D ultrasound video of the embryo is played before and/or after a recording. Optionally, the animation is a video. Optionally, the animation is synthesized. Optionally, the video comprises ultrasound images of the embryo.

FIG. 13 illustrates one embodiment where the voice-sampling solution includes a placeholder 25 on which the infant image is to be placed. The placeholder 25 may be a predefined blank area for the infant image and may be extended out of the display area.

In one embodiment, the user is requested to look at her infant or her infant image. FIG. 16 illustrates one example of such a method, including the following steps. In step 380, playing the phonemes to be recorded. In step 381 asking the user to look at her infant or her infant image. And in step 382, recording the user.

Optional Embodiments of the Auditory Pieces

In one embodiment, the playing device is programmed to have a predefined time for a more didactic auditory piece and a predefined time for a more enjoyable auditory piece. Optionally, the more didactic auditory piece uses the mother's voice, in natural scheme, and with a beat. Optionally, the more enjoyable auditory piece uses a singer's voice, and/or is based on a known melody with accompanying harmonic music.

In one embodiment, the device enables the user to select between the parent's voice and a non-parent voice, such that the parent is able to switch to the non-parent voice whenever he/she does not want the device to play in his/her voice.

In one embodiment, a client selects a required melody, and a set of auditory pieces in the required melody is created with the required phonemes.

In one embodiment, a required mood/ambiance is added to the auditory pieces. For example, “Meditation” auditory pieces having in the background sounds such as sea, bells, or harp; Optimistic; Calm; or Rock/pop/energetic.

In one embodiment, a set of phonemes, optionally representing a language, is available in more than one accent. Optionally, the user is able to select the required accent in which the auditory pieces are to be played.

In one embodiment, a first accent matching a first region or origin is processed and transformed to a second accent matching a second region or origin. In one embodiment, auditory synthesizing software transfers one or more phonemes from a first accent to a second accent.

In one embodiment, one or more of the phonemes is presented in one or more accent or dialect. The parent may select and/or record his required dialects.

In one embodiment, accompanying music is added to the parent's recordings. The frequency of the accompanying music is determined according to the pitch of the parent's recordings, so that the accompanying music and the parent's recordings match. Optionally, the accompanying music is in a MIDI format which allows easy frequency tuning. The accompanying music may be in unison (unisono) or harmonic. For example, until the age of 4 months, the accompanying music may be in unison and after the age of 4 months the accompanying music may be harmonic. The sound volume of the accompanying music may be above, below or equal to the phonemes' volume.

In one embodiment, music in major keys is utilized for emphasizing specific phonemes, while music in minor keys is utilized for the less important phonemes.

In one embodiment, a beat is added to the auditory piece. The beat may help focus the user on the phonemes or on specific phonemes. The beat may resemble a metronome or a drum. The beat may be added to each phoneme, or every predefined number of phonemes, for example, every two, four or eight phonemes. The beat rate may be faster than the phonemes rate (for example, two beat per phonemes), or slower than the phonemes rate (for example, two phonemes per beat). The beat may be optional. The beat may be added as a function of the time of day or the beat may be added as a function of the user's state of activity (such as awake or asleep), or the beat may be manually operated. For example, a beat may accompany an auditory piece played during the day and not accompany an auditory piece played during the night. In one embodiment, the beat is in syncopation, i.e. between the phonemes. In one embodiment, the auditory piece includes phonemes in syncopation and without a melody. Optionally, the phonemes in syncopation and without a melody may be used for difficult-to-grasp phonemes or specific phonemes such as problematic phonemes identified by a therapist. The volume of the beat may be above, below or equal to the phonemes' volume.

Interactive Operation and Determining when to Start Playing Each Auditory Piece

In one embodiment, sucking on a pacifier determines the auditory piece playing. Optionally, the sucking is utilized for determining melody. One sucking-based method includes the step of: (i) measuring infant's sucking properties; (ii) estimating the infant's mental state; and (iii) selecting an auditory piece according to the estimated mental state.

In some embodiments, the auditory piece is not played when the infant is not calm. One method comprises the following steps: identify when the infant is calm; and if calm, play an auditory piece. Another method includes the following steps: play an auditory piece; and stop playing when it is likely that the infant is not calm. Optionally, continue playing when the infant is calm again.

In one embodiment, the infant's activity is measured, for example, using an electronic pacifier, a movement sensor, a camera, or any other appropriate sensor. The measurements are used for one or more of the following: selecting the auditory piece intended to preserve the estimated mental state; providing an energetic melody to an energetic infant and a calm melody to a calm infant; and selecting an auditory piece intended to alter the estimated mental state.

In one embodiment, the auditory pieces are played according to hand or leg movements. The movements may be detected using at least one of the following examples: a rate sensor, a movement sensor, a camera with movement detection, and an optical movement sensor, such as passive IR detector. Alternatively, the auditory pieces are played upon touching the device.

In one embodiment, the device includes a movement sensor, such as a passive infra-red sensor. Using the sensor, the device is operated only when the infant is nearby. Optionally, the device provides feedback to the infant only when the infant moves. For example, the device may answer the infant only if a movement has been detected during the last minute and only if the thermal signature suits that of an infant. Optionally, the thermal signature of the infant is stored in the device and is calibrated by placing the infant in front of the device and selecting the calibration function.

In one embodiment, the auditory pieces are played according to bodily movements. The bodily movements may be measured using any available mechanism. In one embodiment, the auditory pieces are played according to breathing amplitude and/or breathing rate.

In one embodiment, the device monitors the sounds produced by the infant, and reacts accordingly. Optionally, the sounds are monitored using a microphone. Optional feedbacks include: (i) Answering with an auditory piece. The selection of the auditory piece may be related in some manner to the sounds produced by the infant or may be independent of the characteristics of the sounds produced by the infant. (ii) Answering with an auditory piece appropriate to the sound produced by the infant. For example, answering the infant using: similar phoneme(s), similar melody, appropriate sound level, answer related to stimulus provided to the infant, predefined answer that conforms to the current played music, or answer with a sentence recorded by the parent, such as an encouraging or supporting sentence. Optional feedback characteristics include: (i) Waiting until the infant finishes producing the sounds, and then playing the feedback, wherein the feedback may include phonemes and/or other sounds. (ii) Enunciating the auditory piece with varying inflections, for example, concluding with a raised intonation, an open sentence, or a question intonation. (iii) Measuring the infant's loudness and answering in a matching or similar volume. Optionally, the volume is selected according to a pattern that encourages the infant to produce sounds in different volumes and/or other sounds. Optionally, the initial feedback played by the device is louder than the following feedback in order to catch the infant's attention.

In one embodiment, the device “learns” the sound characteristics made by an infant, and/or is calibrated to sounds made by the infant, in order to predominantly initiate feedback to sounds produced by the infant. For example, the device may include a sound-sampling mechanism that obtains sound samples of the infant, and a signaling device by which the user is able to mark which sounds are produced by the infant. Optionally, the sound-sampling mechanism is controlled by the signaling device.

In one embodiment, the device stores or has access to characteristics of typical sounds pronounced by infants. The device uses the characteristics of typical sounds for determining which sound is pronounced by an infant, and optionally initiating a feedback. Some of the feedback's characteristics may be fitted to the measured sounds.

In one embodiment, the device identifies sounds pronounced by the infant and answers by playing corresponding phonemes and/or words in the infant's parent's voice. In this embodiment, waiting for the infant to make a sound encourages the infant to make sounds. Moreover, answering in the parent voice improves the infant's awareness of the played sounds.

In one embodiment, the device has one or more remote controls embedded in toys. By moving the remote controller, the device begins playing. Optionally, different remote controllers (toys) may trigger different phonemes, lights, or movements.

In one embodiment, the infant is moved in synchronization with the playing of the auditory pieces. In one embodiment, visual indications are shown in synchronization with the phonemes. Examples of visual indications include a light, a doll, a painting, or something with attractive colors. In one embodiment, a distinguishable sound, such as bit or another sound that may catch the baby's attention, is played with the auditory piece. In one embodiment, the heat of the infant's hammock, bed, or playpen is changed in order to attract the infant's attention or to provide her with feedback. In one embodiment, mechanical, electronic, and/or electromechanical feedback, such as electrical current, caressing, or flapping is applied with the auditory piece. In one embodiment, a camera is utilized for determining whether the infant notices a phoneme.

In one embodiment, the system is integrated with a toy having at least two states. The first state is an interactive state wherein the toy responds to predefined activations, such as an infant's movements or sounds. The second state is a non-interactive state wherein the toy plays the auditory piece independently.

In one embodiment, it is required that the infant not hear his mother's recordings while the mother is nearby. Therefore, the playing stops when an adult passes nearby. Therefore, the system includes a sensor that identifies the presence of a figure other than the infant. In one example, the figure may be one or more of the following: a human, an animal, a living creature having a minimal size, or a robot. When the figure is identified, the auditory piece and or the volume may change. For example, the system may play an auditory piece containing phonemes and beat, but without melody and accompanying music. Upon sensing a nearby presence, the auditory piece may switch to phonemes with melody and accompanying music and without beat. As another example, the volume of the auditory piece may be muted upon sensing a nearby parent. In some embodiments, the presence may be identified using an electro-optic sensor, such as infra-red (IR) sensor; using an electro-magnetic sensor, such as a radio frequency sensor; using a sound sensor; or using any other appropriate mechanism. U.S. Pat. No. 6,695,672, entitled “Figure with proximity sensor”, which is incorporated herein by reference, describes a useful sensing solution.

Optionally, some of the embodiments are able to connect to the Internet and/or to another communication network for the downloading of, and/or uploading of, required data. Non-limiting examples of required data include recordings (such as, but not limited to, additional voices, phonemes, and/or melodies), software updates, guidelines, online help, collaboration stuff, uploading voice samples and/or recordings, uploading statistical data, etc.

In one embodiment, the playing of the auditory pieces is initiated by an actuation signal. If, while playing the auditory piece, another actuating signal is received, the current auditory piece is played uninterruptedly, and a new auditory piece is played thereafter. Alternatively, if while playing the auditory piece, another actuating signal is received, the received actuating signal is ignored. Examples of actuating signals include a voice pronounced by the baby, detecting another presence that is not the baby, pressing a button, operating a feedback mechanism, or a sensor detecting something above a predefined threshold.

In one embodiment, the system measures the environmental noise level and sets the playing volume accordingly. Optionally, the playing volume can be set so as not to pass a predefined maximum level. For example, the auditory piece may be played at a relatively lower volume when the infant sleeps in a quiet room than when sleeping in the middle of a city with a high environmental noise level, but even in the city, the volume may not exceed a predefined level.

Optionally, the system measures the environmental noise level every predefined time interval and changes the playing level accordingly. Alternatively, the system measures the approximate environmental noise level when starting to play and does not change the volume in the current session. Alternatively, the system measures the environmental noise level in accordance with a predefined sleeping pattern, such as rapid eye movement sleep, and adjusts the playing volume and, optionally, the content to be played according to the sleeping phase.

In one example, the playing volume is at least 5 dB above the environmental noise level. In another example, the playing volume is at least 8 dB above the environmental noise level.

A decibel measurement device may control the playing volume. In one embodiment, a decibel measurement device includes the following elements: microphone placed near the infant; sound analysis hardware for determining the volume of the auditory pieces as heard by the infant; and an indication device enabling the operator to know whether the auditory pieces are played at the recommended sound volume.

In one embodiment, the father and the mother record the phonemes, and the system selects the best performance for each phoneme. In one embodiment, the auditory piece is constructed of a mixture of the parents' recordings. In one embodiment, the system plays each phoneme using both of the parents' voices.

In one embodiment, the device monitors the infant in order to reduce any possible sleeping interference and/or change its operation when it is estimated that the infant is waking. For example, the device may monitor the infant's movements and/or sounds and hold its operation when it is estimated that the infant is waking. Alternatively, the device may change its operation when it is estimated that the infant is waking, such as playing a calmer recording. U.S. Pat. No. 5,551,879, entitled “Dream state teaching machine”, which is incorporated herein by reference, describes a useful solution.

In one embodiment, the device includes a timer for stopping its operation at a predefined time before the infant is expected to wake up. This may prevent the device from disturbing the infant's sleep.

In one embodiment, the system receives the size of the room in which it is placed and sets the playing volume accordingly. In one embodiment, the system measures the distance between the user and the speaker and sets the playing volume according to that distance. This distance measurement enables the user to hear the auditory piece well from almost any location within a reasonable distance. The distance measurement may be performed for example by an infra-red sensor, a radio transmitter carried by the user or any other appropriate means for distance measurements.

In one embodiment, a parent may download additional auditory pieces in the parent's voice from a server, without having to undergo additional recordings. The additional auditory pieces are composed of the already available phonemes previously recorded by the parent.

In one embodiment, a service including the following steps is provided to the parents: (i) At least one parent records at least a minimum number of phonemes. (ii) The recorded phonemes are used to create auditory pieces in the parent's voice. (iii) The parent is able to select the required auditory pieces from a predefined set of auditory pieces. The auditory pieces may differ in melody, selected phonemes, phonemes mixture, pitch, rhythm, or other properties. (iv) The service composes the required auditory pieces from the already available phonemes previously recorded by the parent. Alternatively, the service composes the required auditory pieces from the available voice characteristics of the parent. In some embodiments, the main idea is that the parent does not have to undergo additional recordings in order to receive additional auditory pieces in his own voice.

It is to be understood that the disclosed embodiments are not limited to infants and may be used, in some cases, with children or adults. For example, following a stroke, an accident, a severe trauma, or any other problem that damages the memory, it is possible to use some of the embodiments for learning the language again using imitation. In one embodiment, the system plays phonemes and then the user repeats the phonemes he hears. In one embodiment, the system plays a word and then plays its phonemes separately. It is to be noted that the disclosed embodiments are useful for infants but may be used for any age, such as for children, teenagers, and adults.

In one embodiment, physiological parameters of the user are measured in order to assess which voice is most suitable to the target audience. For example, an infant or a stroke patient may be connected to a pulse rate meter and a sweat meter. Then the user is exposed to two or more voices and/or to different types of auditory pieces: for example, the mother's voice and the father's voice, or the wife's voice and the son's voice, or phonemes in a first melody and a second melody. According to the measured physiological response of the user, it is possible to select the most appropriate voice/melody for the specific user. For example, if the infant is calmer and/or more focused while hearing his mother's voice than while hearing his father's voice, it may be better to play the phoneme music using the mother's voice.

In one embodiment, the system is integrated with a toy playing a specific phoneme or a specific auditory piece each time a predefined event occurs. The specific phoneme or specific auditory piece changes after every number of predefined times the event occurred. For example, the event may include one or more of the following: moving the toy, touching the toy, talking to the toy or just talking, or bringing the toy close to other toys. In one example the toy plays an auditory piece made of isolated phonemes and the event is “moving the toy 8 times”, such that the toy plays the same phoneme in each 8 successive movements of the toy. In the ninth movement of the toy, the toy plays a different phoneme. In one embodiment, the toy plays phonemes related to tonal language (such as Chinese, Vietnamese, That, Lao, and Burmese). In this case, the same phoneme may be played in various pitches. Continuing the last example, the 8 occurrences of a phoneme may be played in 2 or 4 different pitches, for example, starting with 4 low pitch occurrences and continuing with 4 higher pitch occurrences. Alternatively, each occurrence is in a different pitch.

In one embodiment, the auditory piece is accompanied with visual indications. For example, different phonemes may be associated with different lights or light combinations. In one embodiment, the device includes a light source(s) and/or vibrating mechanism. The lights and/or vibrations may be coordinated with the played feedback. For example, lights and/or vibration may be operated every few minutes or after/with every few played feedbacks.

In one embodiment, the device samples the sounds the infant makes and plays a related auditory piece. For example, the infant pronounces an ‘A’, and the device plays “A A A A A A A A”, optionally according to one of the melodies.

In one embodiment, a speech therapist diagnoses the child's problematic phonemes. Then, the software produces an auditory piece tailored to the problematic phonemes of the patient. Optionally, the therapist may enter the severity of each problematic phoneme. The degree of difficulty the patient encounters in pronouncing the phoneme may determine the number of occurrences of each phoneme in the resulted auditory piece. Optionally, when the therapist identifies a problematic phoneme, the software suggests to the therapist related phonemes, such as phonemes of the same family, so that the therapist will be able to easily enter the related phonemes to the auditory piece. Alternatively, after the therapist selects a phoneme, the software adds its related phonemes.

In one embodiment, the device is manufactured with a prerecorded voice. The user may change the prerecorded voice and/or load his own voice recordings.

In one embodiment, the user can select the auditory pieces to be played.

In one embodiment, the device stores its last playing location and continues playing from that point. In one embodiment, the device plays the different auditory pieces and/or phonemes according to a predefined order. For example, (i) playing the different phonemes approximately homogeneously across the sleeping hours, (ii) playing the more important phonemes in the middle of the sleeping hours, and (iii) playing calmer recordings towards the end of the sleeping hours.

In one embodiment, a device includes a central control unit controlling at least two playing devices. Optionally, each playing device includes a speaker operated by the central control unit, wherein each infant hears the recordings intended for her. The playing device may also include any of the sensors described herein.

Certain features of the embodiments, which may have been, for clarity, described in the context of separate embodiments, may also be provided in various combinations in a single embodiment. Conversely, various features of the embodiments, which may have been, for brevity, described in the context of a single embodiment, may also be provided separately or in any suitable sub-combination.

The embodiments are not limited in their applications to the details of the order or sequence of steps of operation of methods, or to details of implementation of devices, set in the description, drawings, or examples.

While the methods disclosed herein have been described and shown with reference to particular steps performed in a particular order, it will be understood that these steps may be combined, sub-divided, or reordered to form an equivalent method without departing from the teachings of the embodiments. Accordingly, unless specifically indicated herein, the order and grouping of the steps is not a limitation of the embodiments.

Any citation or identification of any reference in this application shall not be construed as an admission that such reference is available as prior art to the embodiments of the present invention.

While the embodiments have been described in conjunction with specific examples thereof, it is to be understood that they have been presented by way of example, and not limitation. Moreover, it is evident that many alternatives, modifications and variations will be apparent to those skilled in the art. Accordingly, it is intended to embrace all such alternatives, modifications and variations that fall within the spirit and scope of the appended claims and their equivalents. In the claims, means-plus-function clauses are intended to cover the structures described herein as performing the recited function and not only structural equivalents, but also equivalent structures.

What is claimed is:

1. A device operative to play auditory pieces to an infant for stimulating the development of phonetic categories; the device determines the auditory pieces to be played to the infant according to the age of the infant; and the auditory pieces comprising isolated phonemes in the infant's parent's voice.

2. The device of claim 1, further comprising a memory element operative to store the prerecorded isolated phonemes in the infant's parent's voice, and a computing element programmed to create the auditory pieces to be played from the prerecorded isolated phonemes.

3. The device of claim 1, wherein the auditory pieces comprise more vowels than consonants when the infant is less than about 3 months old, and comprise more consonants than vowels when the infant is more than about 7 months old.

4. The device of claim 1, wherein the device further comprises a memory element operative to store prerecorded auditory pieces in the infant's parent's voice.

5. The device of claim 1, wherein the device is coupled to a sensor arranged to measure the infant activity; the infant activity is utilized to estimate the infant's development, and the device also determines the auditory pieces to be played to the infant according to the infant's estimated development.

6. The device of claim 5, wherein the sensor measures the infant's movements.

7. The device of claim 5, wherein the sensor measures the infant's babbling.

8. The device of claim 1, wherein the device is coupled to a weight sensor arranged to measure the infant's weight; and the device determines the auditory pieces to be played to the infant according to the infant's weight.

9. The device of claim 1, wherein the device further comprises an amplifier and a speaker.

10. A device for playing auditory pieces, comprising: a memory element operative to store prerecorded auditory pieces in the infant's parent's voice; a computing element programmed to select at least one auditory piece to be played, according to the infant's age.

11. The device of claim 10, wherein the auditory pieces comprise isolated phonemes.

12. The device of claim 11, wherein the infant's age is estimated.

13. The device of claim 11, wherein the device further comprises an amplifier and a speaker.

14. A method for preparing an auditory piece for prelingual language development, comprising: registering an infant's age; accessing at least one phoneme recorded in the infant's parent's voice; and building an auditory piece from the recorded phoneme, appropriate to the infant's age.

15. The method of claim 14, wherein the auditory piece is built according to a predefined melodic pattern.

16. The method of claim 14, wherein, the auditory piece comprises isolated phonemes, and most of the phonemes are repeated successively at least 3 times.

17. The method of claim 14, further comprising the step of building a plurality of auditory pieces appropriate to different ages; and playing the appropriate auditory pieces according to the infant's age.

18. The method of claim 14, further comprising the step of playing different audio pieces, comprising different mixtures of phonemes, at different ages.
